(19) United States
(12) Patent Application Publication
(10) Pub. No.: US 2006/0003116 A1
(43) Pub. Date: Jan. 5, 2006

(54) Inkjet elements comprising calcium metasilicate needles

(75) Inventor: Gregory E. Missell, Penfield, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/882,141

(22) Filed: Jun. 30, 2004

(51) Int. Cl. B41M 5/00

(52) U.S. Cl. 428/32.34

(57) ABSTRACT

An inkjet recording element comprising a support having thereon a calcium-metasilicate-containing layer, optionally in combination with organic or inorganic particles, in a polymeric binder, the calcium-metasilicate being in the form of needles having an average length of from 1 μm to 50 μm. The presence of the needles prevents cracking and adds flexibility to the layer after coating.

### FIELD OF THE INVENTION

This invention relates to an inkjet recording element, more particularly to an inkjet recording element that contains calcium metasilicate.

### BACKGROUND OF THE INVENTION

In a typical inkjet recording or printing system, ink droplets are ejected from a nozzle at high speed towards a recording element or medium to produce an image on the medium. The ink droplets, or recording liquid, generally comprise a recording agent, such as a dye or pigment, and a large amount of solvent. The solvent, or carrier liquid, typically is made up of water, an organic material such as a monohydric alcohol, a polyhydric alcohol or mixtures thereof.

While a wide variety of different types of inkjet recording elements have been proposed heretofore, there are many unsolved problems in the art and many deficiencies in the known products that have limited their commercial usefulness. The requirements for an inkjet recording medium or element for inkjet recording are very demanding. Large amounts of ink are often required for printing high quality, photographic-type images.

The recording element must be capable of absorbing or receiving large amounts of ink applied to the image-forming surface of the element as rapidly as possible in order to produce recorded images having good quality, including high optical density and low coalescence. In addition, it is desirable that the element can be handled without smearing shortly after printing and is free of cracking or other defects that may result from coating or later keeping.

One typical inkjet recording element comprises a support having thereon at least one base layer for substantially absorbing carrier fluid and, for substantially retaining the ink colorant, at least one ink-receiving or image-forming layer, also referred to herein as an ink-retaining layer.

Many inkjet receivers are porous and consist of organic or inorganic particles that form pores by the spacing between the particles. The ink and solvents are pulled into this structure by capillary forces. In order to have enough pore volume or capacity to absorb heavy ink laydowns, these coatings are usually coated to a dry thickness on the order of 40 μm to 60 μm, which can be costly because of the layer thickness.

To form a porous layer, a binder can be added to hold the particles together. However, to maintain a high pore volume, the amount of binder should be as low as possible. Too much binder would start to fill the pores between the particles or beads, which will reduce ink absorption. Too little binder will reduce the integrity of the coating causing cracking. Once cracking starts in an inkjet coating, typically at the bottom of the layer, it tends to migrate throughout the layer.

U.S. Pat. No. 6,544,630 relates to inkjet recording elements (receivers) comprising a resin-coated support having thereon an ink-retaining layer comprising voided cellulosic fibers and organic or inorganic particles in a polymeric binder, the length of the voided fibers being from about 10 μm to about 50 μm.

Calcium metasilicate materials have been previously advertised as a reinforcing agent to enhance mechanical strength properties in coatings and to prevent cracking. Given the wide variety of coatings, however, including industrial applications, the use and benefits of such materials in inkjet recording elements as described herein has, to Applicants' knowledge, heretofore been untried and, hence, unrecognized. Other prior-art applications of calcium metasilicate include cementitious board and block fillers and reinforcing epoxy and other resin-based adhesives.

It is an object of this invention to provide an inkjet receiver that improves previous inkjet receivers by exhibiting little or no tendency to cracking.

### SUMMARY OF THE INVENTION

This and other objects are provided by the present invention comprising an inkjet recording element comprising a support having thereon at least one continuous layer comprising calcium metasilicate, preferably in combination with organic and/or inorganic particles, in a polymeric binder. The calcium metasilicate is in the form of needles, the length (mean particle size) of the calcium metasilicate being from 1 μm to 50 μm.

Using the invention, an inkjet receiver is obtained which has lesser tendency to cracking than comparable prior-art elements.

The calcium-metasilicate-containing layer can serve as an ink-retaining layer in addition to a base layer if sufficiently thick, that is, serving to retain the image-forming ink and, during printing, absorbing a substantial amount of carrier fluid. Optionally, an additional base layer or a porous support can contribute to absorbing carrier fluid.

In another embodiment, the calcium-metasilicate-containing layer is used as a substrate or base layer below a porous image-receiving layer. In this case, it is preferred that the voids in the ink-receiving layer are open to (connect with) and preferably have a void size similar to the voids in the calcium-metasilicate-containing base layer for optimal interlayer absorption.

In particular, one embodiment of the present invention comprises an inkjet recording element comprising a support having thereon an ink-retaining (image-receiving) layer comprising calcium metasilicate in the form of needles, the length of the calcium metasilicate being from 1 μm to 50 μm, and a polymeric binder. In this case, to reduce the surface roughness, the calcium metasilicate-containing layer will also comprise organic and/or inorganic particles of a smaller size. Such an inkjet receiver will typically have a matte finish rather than a glossy finish.

Another embodiment of the present invention comprises an inkjet recording element comprising a support having thereon a base layer comprising calcium metasilicate, and optionally organic and/or inorganic particles in a polymeric binder, the length of the calcium metasilicate being from 1 μm to 50 μm. Although the calcium metasilicate may comprise essentially all of the particles in the layer, in a preferred embodiment, the ratio of the calcium metasilicate to the organic or inorganic particles is from 90:10 to 25:75. The calcium metasilicate is preferably present in an amount of at least 25 weight percent, based on the total dry weight of the pore-forming particles, including inorganic and/or organic particles present. In this case, the presence of a separate image-receiving layer allows for a glossy surface.

The presence of the calcium metasilicate has been found to significantly help in preventing or minimizing cracking of particulate coatings upon drying. The coating and subsequent drying of relatively small particles and/or relatively thicker coatings tends to result in cracking defects. Relatively smaller particles can allow for smaller capillaries that improve the speed of absorption, but provides less porosity. The presence of needles of calcium metasilicate in the coating has been found to act as an effective reinforcement means to prevent this cracking and to add flexibility to the coating. The calcium metasilicate also optionally enhances the porous structure.

The invention is particularly advantageous for relative thick coatings at least 30 or 50 μm thick comprising sub-micron particles, since as indicated above coatings with smaller particles and/or thicker coatings are more prone to cracking problems. Typically, such coatings require as much as 20-30 percent by weight of binder to prevent cracking, whereas the present invention allows for significantly less amount of binder and commensurately greater absorption capability.

The use of a calcium-metasilicate-containing layer can optionally provide increased porosity compared to organic or inorganic particles usually used in porous layers of many inkjet-recording elements. Alternatively, the calcium metasilicate can be used to adjust the porosity of the layer, for example, to provide a porosity that better matches the porosity of an adjacent layer. This needle structure of the calcium-metasilicate-containing layer provides fast dry times with very heavy ink laydown volumes.

Another embodiment of the invention relates to an inkjet printing method comprising the steps of: (a) providing an inkjet printer that is responsive to digital data signals; (b) loading the inkjet printer with the inkjet recording element described above; (c) loading the inkjet printer with a pigmented inkjet ink; and (d) printing on the herein-described inkjet recording element using the inkjet ink in response to the digital data signals. In the case of inkjet recording elements having a fusible top layer, an optional further step comprises fusing of at least the top layer of the inkjet recording element. Thus, the additional step has the advantage of providing stain and water resistance.

As used herein, the terms “over,” “above,” and “under,” and the like, with respect to layers in the inkj et media, refer to the order of the layers over the support, but do not necessarily indicate that the layers are immediately adjacent or that there are no intermediate layers.

In the description below, the term layer is used to mean the product of one or more contiguous or adjacent coatings, so that as used herein the term layer refers to a layer unit that may be divided into one or more sub-layers.

### DETAILED DESCRIPTION OF THE INVENTION

As indicated above, the present invention relates to the use of calcium metasilicate in the form of a needle structure in a layer of the inkjet recording element.

Examples of calcium metasilicate that can be used in the invention include VANSIL acicular Wollastonite. Such a material can also be represented by the commonly used formula for calcium metasilicate or CaSiO₃. VANSIL WG, for example, is a high aspect ratio, long needle grade of Wollastonite. Other useful grades, depending on the particular inkjet recording system, include VANSIL HR-1500 and HR-325, which are all commercially available from R.T. Vanderbilt Co., Inc., Norwalk, Conn. (webstite:www.rtvanderbilt.com).

For use in the calcium-metasilicate-containing layer of the present invention, the needles can vary in length from 1 μm to 50 μm, with the preferred length of less than 30 μm, more preferably less than 10 μm, most preferably about 2 to 9.0 μm. The average aspect ratio is suitably at least 5:1, preferably 8:1 to 20:1, more preferably about 10:1 to 16:1, most preferably at least about 12:1. The average length of the calcium metasilicate needles is suitably from 10 μm to 50 μm. The density of calcium metasilicate is typically about 2.9 g/cm³. In one embodiment, the surface area (N₂ B.E.T.) is, for example, 1 to 4 m²/g. The calcium metasilicate needles may be treated or surface modified, for example, subjected to silane treatment.

In a preferred embodiment of the invention, the calcium-metasilicate-containing base layer is a porous layer that contains organic or inorganic particles.

Examples of organic particles that may be used in this layer include polymer beads, including but not limited to acrylic resins such as methyl methacrylate, styrenic resins, cellulose derivatives, polyvinyl resins, ethylene-allyl copolymers and polycondensation polymers such as polyesters. Hollow styrene beads are a preferred organic particle for certain applications.

Other Examples of organic particles which may be used include core/shell particles such as those disclosed in U.S. Pat. No. 6,492,006 issued Dec. 10, 2002 to Kapusniak et al., and homogeneous particles such as those disclosed in U.S. Pat. No. 6,475,602 issued Nov. 5, 2002 to Kapusniak et al., the disclosures of which are hereby incorporated by reference.

Examples of inorganic particles that may be used in the calcium-metasilicate-containing layer of the invention include silica, alumina, titanium dioxide, clay, calcium carbonate, barium sulfate, or zinc oxide.

In a preferred embodiment, the average primary particle size of the organic or inorganic particles is about 0.3 μm (300 nm) to about 5 μm, preferably 0.5 μm (500 nm) to less than 1.0 μm. A plurality of inorganic particles such as alumina may agglomerate into larger secondary particles. As mentioned above, smaller particles provide smaller capillaries, but tend to be more prone to cracking because binder starved in view of the large surface area created by the particles. On the other hand, particles that are too large may be brittle or prone to cracking because of less contact points, for example, if the coating has a thickness equal to only a few beads making up the dried coating.

Any polymeric binder may be used in the ink-retaining layer of the inkjet recording element employed in the invention.

In general, good results have been obtained with gelatin, polyurethanes, vinyl acetate-ethylene copolymers, ethylene-vinyl chloride copolymers, vinyl acetate-vinyl chloride-ethylene terpolymers, acrylic polymer, and polyvinyl alcohol or derivatives thereof. Preferably, the binder is a water-soluble hydrophilic polymer, most preferably polyvinyl alcohol or the like.

In a preferred embodiment of the invention, the porous calcium-metasilicate-containing layer comprises between 75% by weight and 95% by weight of particles and between about 5% and 25% by weight of a polymeric binder, preferably from about 82% by weight to about 92% by weight of particles and from about 18% by weight to about 8% by weight of a polymeric binder, most preferably about 10% by weight of binder. In one embodiment, about 100 percent of the particles in the calcium-metasilicate-containing layer are the calcium-metasilicate particles, in the absence of organic or inorganic particles or beads. Preferably, the calcium-metasilicate-containing layer comprises at least 25 percent by weight of calcium-metasilicate particles (in the form of needles). In one preferred embodiment, the ratio of the needles to other organic or inorganic (substantially spherical) is about 30:70 to 70:30, preferably about 40:60 to 50:40, more preferably about 45:55 to 55:45.

As mentioned above, the amount of binder is desirably limited, because when ink is applied to the inkjet media, the typically aqueous liquid carrier tends to swell the binder and close the pores and cause bleeding and other problems. The presence of calcium-metasilicate allows less than 25 weight percent of binder, to maintain porosity, whereas as much as 50% by weight of binder have been necessary in some comparable media to prevent cracking.

In a preferred embodiment, the polymeric binder may be a compatible, preferably hydrophilic polymer such as poly(vinyl alcohol), poly(vinyl pyrrolidone), gelatin, cellulose ethers, poly(oxazolines), poly(vinylacetamides), partially hydrolyzed poly(vinyl acetate/vinyl alcohol), poly(acrylic acid), poly(acrylamide), poly(alkylene oxide), sulfonated or phosphated polyesters and polystyrenes, casein, zein, albumin, chitin, chitosan, dextran, pectin, collagen derivatives, collodian, agar-agar, arrowroot, guar, carrageenan, tragacanth, xanthan, rhamsan and the like. Preferably, the hydrophilic polymer is poly(vinyl alcohol), hydroxypropyl cellulose, hydroxypropyl methyl cellulose, a poly(alkylene oxide), poly(vinyl pyrrolidinone), poly(vinyl acetate) or copolymers thereof or gelatin.

In one preferred embodiment, the calcium-metasilicate-containing layer comprises porous alumina or silica in a crosslinked poly(vinyl alcohol) binder.

In order to impart mechanical durability to the calcium-metasilicate-containing layer, crosslinkers which act upon the binder discussed above may be added in small quantities. Such an additive improves the cohesive strength of the layer. Crosslinkers such as carbodiimides, polyfunctional aziridines, aldehydes, isocyanates, epoxides, polyvalent metal cations, vinyl sulfones, pyridinium, pyridylium dication ether, methoxyalkyl melamines, triazines, dioxane derivatives, chrom alum, zirconium sulfate and the like may be used. Preferably, the crosslinker is an aldehyde, an acetal or a ketal, such as 2,3-dihydroxy-1,4-dioxane.

The calcium-metasilicate-containing layer is typically at least 10 μm in thickness (dried), more preferably at least 15 μm or 20 μm, depending on the presence of other liquid-carrier absorbing layers, preferably about 30 to 60 μm. For example, in one embodiment, the calcium-metasilicate-containing layer is 30 to 70 μm thick, preferably at least 35 μm. In the case of an inkjet recording element with a porous support such as paper, the calcium-metasilicate-containing layer may be 20 μm to 60 μm thick, preferably at least 25 μm.

As indicated below, other conventional additives may be included in the calcium-metasilicate-containing layer, which may depend on the particular use for the recording element. In the case of dye-based inks used to image the recording element, the calcium-metasilicate-containing layer can comprise a mordant, for example, of a type described in more detail below.

In one embodiment of the invention, the calcium-metasilicate-containing layer according to the present invention is located under at least one image-receiving layer and absorbs a substantial amount of the liquid carrier applied to the inkjet recording element, but substantially less dye or pigment than the overlying layer or layers. Thus, the calcium-metasilicate-containing layer can be referred to as a base layer, sump layer, or ink-carrier-liquid receptive layer.

As noted above, a porous image-receiving layer containing interconnecting voids can be used in the inkjet recording element over the calcium-metasilicate-containing layer. The voids in the image-receiving layer provide a pathway for an ink to penetrate appreciably into the calcium-metasilicate-containing layer, thus allowing the calcium-metasilicate-containing layer to contribute to the dry time. A non-porous image-receiving layer or a porous image-receiving layer that contains closed cells will not allow the substrate to contribute to the dry time. It is preferred, therefore, that the voids in the ink-receiving layer are open to (connect with) and preferably (but not necessarily) have a void size similar to the voids in the calcium-metasilicate-containing layer for optimal interlayer absorption.

Interconnecting voids in an image-receiving layer may be obtained by a variety of methods. For example, the layer may contain particles dispersed in a polymeric binder. The particles may be organic such as poly(methyl methacrylate), polystyrene, poly(butyl acrylate), etc. or inorganic such as silica, alumina, zirconia, titania, calcium carbonate, and barium sulfate. In a preferred embodiment of the invention, the particles have a particle size of from about 5 nm to about 15 μm.

The polymeric binder which may be used in the image-receiving layer of the invention, can be, for example, a hydrophilic polymer such as poly(vinyl alcohol), polyvinyl acetate, polyvinyl pyrrolidone, gelatin, poly(2-ethyl-2-oxazoline), poly(2-methyl-2-oxazoline), poly(acrylamide), chitosan, poly(ethylene oxide), methyl cellulose, ethyl cellulose, hydroxyethyl cellulose, hydroxypropyl cellulose, etc. Other binders can also be used such as hydrophobic materials such as poly(styrene-co-butadiene), a polyurethane latex, a polyester latex, poly(n-butyl acrylate), poly(n-butyl methacrylate), poly(2-ethylhexyl acrylate), a copolymer of n-butylacrylate and ethylacrylate, a copolymer of vinylacetate and n-butylacrylate, etc.

In another preferred embodiment of the invention, the volume ratio of the particles to the polymeric binder is from about 1:1 to about 15:1.

Other additives may also be included in the image-receiving layer such as pH-modifiers like nitric acid, cross-linkers, rheology modifiers, surfactants, UV-absorbers, biocides, lubricants, dyes, dye-fixing agents or mordants, optical brighteners etc.

An image-receiving layer may be applied to one or both substrate surfaces through conventional pre-metered or post-metered coating methods such as blade, air knife, rod, roll coating, etc. The choice of coating process would be determined from the economics of the operation and in turn, would determine the formulation specifications such as coating solids, coating viscosity, and coating speed.

The image-receiving layer thickness may range from about 1 to about 40 μm, preferably between 4 and 10 μm.

In one embodiment of the invention, the inkjet recording element has a fusible top layer. The inkjet recording element can be specially adapted for either pigmented inks or dye-based inks, or designed for both. One embodiment of such a recording element comprises a support having thereon in order:
a) a fusible, porous pigment-trapping layer comprising fusible polymeric particles and optionally a binder; and
b) a base layer that is a calcium-metasilicate-containing layer as described above.

The support may optionally function as an ink-carrier-receptive layer or sump layer in combination with the base layer.

The term “pigment-trapping layer” is used herein to mean that, in use, preferably at least about 75% by weight, more preferably substantially all, of the pigment colorant in the inkjet ink remains in the pigment-trapping layer.

The fusible, polymeric particles employed in the uppermost pigment-trapping layer of the invention may have a particle size conducive to forming a porous layer. In a particularly preferred embodiment of the invention, the particle size of the fusible, polymeric particle may range from about 0.5 to about 10 μm. In one embodiment, the monodispersity Dp is less than 1.3.

The particles employed in the dye-trapping layer may be formed from any polymer that is fusible, i.e., capable of being converted from discrete particles into a substantially continuous layer through the application of heat and/or pressure.

Upon fusing, via the application of heat and/or pressure, the air-particle interfaces present in the original porous structure of the image layer are eliminated, and a non-scattering, substantially continuous layer forms which contains the printed image.

In a preferred embodiment of the invention, the fusible, polymeric particles in the pigment-trapping layer comprises a condensation polymer or an addition polymer, for example, a styrenic polymer, a vinyl polymer, an ethylene-vinyl chloride copolymer, a polyacrylate, poly(vinyl acetate), poly(vinylidene chloride), and/or a vinyl acetate-vinyl chloride copolymer, a polyester polymer, a polyurethane polymer, a cellulose polymer, or a cellulose ester polymer.

The uppermost porous ink-trapping layer of fusible polymeric particles may, in addition, optionally contain a film-forming hydrophobic binder. The presence of a minor amount of binder may provide more pre-fusing raw-stock keeping, durability, and handling capability. Such a film-forming, hydrophobic binder can be any film-forming hydrophobic polymer capable of being dispersed in water. Preferably, however, there is no binder. If a binder is used, it preferably should be used in a minor amount.

The particle-to-binder ratio of the particles and optional binder employed in the a fusible, porous ink-trapping layer can range between about 100:0 and 60:40, preferably between about 100:0 and about 90:10. In general, a layer having particle-to-binder ratios outside the range stated will usually not be sufficiently porous to provide good image quality.

The fusible, porous ink-trapping layer is usually present in an amount from about 1 g/m² to about 50 g/m², preferably in an amount from about 1 g/m² to about 10 g/m².

The calcium-metasilicate-containing base layer receives the ink-carrier liquid after it has passed through the porous pigment-trapping layer where substantially all the colorant has been removed. In a preferred embodiment, the base layer is present in an amount from about 1 g/m² to about 50 g/m², more preferably from about 10 g/m² to about 45 g/m².

Another embodiment of an inkjet recording element in accordance with the present invention, in which there is a fusible uppermost layer, and in which the recording element has a design that may be advantageous for use with dye-based inks, comprises a support having thereon in order:
a) a fusible, porous ink-transporting layer comprising fusible polymeric particles and optionally a binder;
b) an optional (also fusible) dye-trapping layer; and
c) a base layer that is a calcium-metasilicate-containing layer as described.

Preferably there is an dye-trapping layer between the ink-transporting layer and the calcium-metasilicate-containing base layer to substantially trap the dye image. However, the calcium-metasilicate-containing base layer can also function as a dye-trapping layer if desired, for example, by containing a mordant. Alternatively, a mordant can be present in both a dye-trapping layer and the underlying base layer.

The support may optionally function as an ink-carrier-receptive or sump layer in combination with the base layer.

In regard to the present method, the term “ink-transporting layer” is used herein to mean that, in use, most (50% by weight), preferably at least about 75% by weight, more preferably substantially all, of the dye colorant in the inkjet ink passes through and out of the ink-transporting layer.

In this embodiment, the dye-trapping layer, if present, is a fusible layer and, after receiving the ink from the uppermost ink-transporting layer, preferably retains substantially all the dye, and allows for the passage of the ink-carrier liquid to the underlying base layer.

In this embodiment of the invention, the fusible, polymeric particles in the ink-transporting layer and/or optional dye-trapping layer can comprise those listed above for the fusible pigment-trapping layer.

A dye mordant employed in the optional dye-trapping layer and/or in the calcium-metasilicate-containing layer can be any material that is substantive to the inkjet dyes. In this embodiment, the dye mordant removes dyes from the ink received from the porous ink-transporting layer and fixes the dye within the dye-trapping layer. Examples of such mordants include cationic lattices such as disclosed in U.S. Pat. No. 6,297,296 and references cited therein, cationic polymers such as disclosed in U.S. Pat. No. 5,342,688, and multivalent ions as disclosed in U.S. Pat. No. 5,916,673, the disclosures of which are hereby incorporated by reference. Examples of these mordants include polymeric quaternary ammonium compounds, or basic polymers, such as poly(dimethylaminoethyl)-methacrylate, polyalkylenepolyamines, and products of the condensation thereof with dicyanodiamide, amine-epichlorohydrin polycondensates. Further, lecithins and phospholipid compounds can also be used. Specific examples of such mordants include the following: vinylbenzyl trimethyl ammonium chloride/ethylene glycol dimethacrylate; poly(diallyl dimethyl ammonium chloride); poly(2-N,N,N-trimethylammonium)ethyl methacrylate methosulfate; poly(3-N,N,N-trimethyl-ammonium)propyl methacrylate chloride; a copolymer of vinylpyrrolidinone and vinyl(N-methylimidazolium chloride; and hydroxyethylcellulose derivatized with 3-N,N,N-trimethylammonium)propyl-chloride. In a preferred embodiment, the cationic mordant is a quaternary ammonium compound.

In order to be compatible with the mordant, both the binder and the polymer in the layer or layers in which it is contained should be either uncharged or the same charge as the mordant. Colloidal instability and unwanted aggregation could result if a polymer or the binder in the same layer had a charge opposite from that of the mordant.

The optional dye-trapping layer may comprise fusible particles in an amount ranging from about 95 to about 60 parts by weight, the binder may range from about 40 to about 5 parts by weight, and the dye mordant may range from about 2 parts to about 40 parts by weight. More preferably, the dye-trapping layer comprises about 80 parts by weight fusible particles, about 10 parts by weight binder, and about 10 parts by weight dye mordant.

In this embodiment, the porous base layer receives the ink-carrier liquid after the ink has passed through the porous ink-transporting layer and through the porous dye-trapping layer where substantially all the dye has been removed.

In this embodiment, the base layer is present in an amount from about 1 g/m² to about 50 g/m², preferably from about 10 g/m² to about 45 g/m². The dye-trapping layer is present in an amount from about 1 g/m² to about 50 g/m², preferably in an amount from about 1 g/m² to about 10 g/m².

In general, the base layer will have a thickness of about 10 μm to about 50 μm, the porous dye-trapping layer residing thereon will have a thickness of about 2 μm to about 20 μm, and the porous ink-transporting layer residing thereon will usually have a thickness of about 2 μm to about 20 μm.

In the case of a recording element in which there is a fusible top layer, the fusible, porous ink-trapping layer or ink-transporting layer is, after printing, heat and/or pressure fused to form a substantially continuous overcoat layer on the surface. In addition, if present, the dye-trapping layer can also be fused at the same time. Upon fusing, these layers are rendered non-light scattering. Fusing may be accomplished in any manner which is effective for the intended purpose. A description of a fusing method employing a fusing belt can be found in U.S. Pat. No. 5,258,256, and a description of a fusing method employing a fusing roller can be found in U.S. Pat. No. 4,913,991, the disclosures of which are hereby incorporated by reference. Preferably a fusing roller is used, advantageously facilitated by the low Tg bead polymer.

In a preferred embodiment, fusing is accomplished by contacting the surface of the element with a heat fusing member, such as a fusing roller or fusing belt. Thus, for example, fusing can be accomplished by passing the element through a pair of heated rollers, heated to a temperature of about 60° C. to about 160° C., using a pressure of 5 to about 15 MPa at a transport rate of about 0.005 m/sec to about 0.5 m/sec.

Whatever the particular type of recording element, whether fusible or non-fusible, designed for dye-based inks, pigmented inks or both, the recording element comprises, under the calcium-metasilicate-containing layer, a support which support may be opaque, translucent, or transparent. There may be used, for example, plain papers, resin-coated papers, various plastics including a polyester resin such as poly(ethylene terephthalate), poly(ethylene naphthalate) and poly(ester diacetate), a polycarbonate resin, a fluorine resin such as poly(tetra-fluoro ethylene), metal foil, various glass materials, and the like. In a preferred embodiment, the support is a resin-coated paper. The thickness of the support employed in the invention can be from about 12 to about 500 μm, preferably from about 75 to about 300 μm.

The support can also comprise an open-pore polyolefin, an open-pore polyester, or an open-pore membrane. An open-pore membrane can be formed in accordance with the known technique of phase inversion. Examples of a porous ink-receiving layers comprising an open-pore membrane are disclosed in U.S. Pat. No. 6,491,941 issued Dec. 24, 2002 and U.S. Pat. No. 6,503,607 issued Jan. 7, 2003, both of Landry-Coltrain et al., hereby incorporated by reference. An open-pore polyester is disclosed in U.S. Pat. No. 6,409,334 to Campbell et al., hereby incorporated by reference in its entirety.

If desired, in order to improve the adhesion of the base layer to the support, the surface of the support may be corona-discharge-treated prior to applying the base layer or solvent-absorbing layer to the support.

Since the inkjet recording element may come in contact with other image recording articles or the drive or transport mechanisms of image-recording devices, additives such as surfactants, lubricants, matte particles and the like may be added to the element to the extent that they do not degrade the properties of interest.

The layers described above, including the base layer, the dye-trapping layer, the ink-transporting layer, etc. may be coated by conventional coating means onto a support material commonly used in this art. Coating methods may include, but are not limited to, wound wire rod coating, slot coating, slide hopper coating, gravure, curtain coating and the like. Some of these methods allow for simultaneous coatings of two or more layers, which is preferred from a manufacturing economic perspective. After coating, the inkjet recording element may be subject to calendaring or supercalendering to enhance surface smoothness.

The present invention does not require, but permits, the use or addition of various organic and inorganic materials such as pigments, anti-block agents, antistatic agents, plasticizers, dyes, stabilizers, nucleating agents, and other addenda known in the art to an above-described layer. These materials may be incorporated into one or more of the coatings used to make the recording element using known techniques.

Inkjet inks used to image the recording elements of the present invention are well known in the art. The ink compositions used in inkjet printing typically are liquid compositions comprising a solvent or carrier liquid, dyes or pigments, humectants, organic solvents, detergents, thickeners, preservatives, and the like. The solvent or carrier liquid can be solely water or can be water mixed with other water-miscible solvents such as polyhydric alcohols. Inks in which organic materials such as polyhydric alcohols are the predominant carrier or solvent liquid may also be used. Particularly useful are mixed solvents of water and polyhydric alcohols. If dyes are used in such compositions, they are typically water-soluble direct or acid type dyes. Such liquid compositions have been described extensively in the prior art including, for example, U.S. Pat. Nos. 4,381,946; 4,239,543; and 4,781,758.

Although the recording elements disclosed herein have been referred to primarily as being useful for inkjet printers, they also can be used as recording media for pen plotter assemblies. Pen plotters operate by writing directly on the surface of a recording medium using a pen consisting of a bundle of capillary tubes in contact with an ink reservoir.

The following examples further illustrate the invention.

### COMPARATIVE EXAMPLE 1

A 25% solids aqueous solution was made containing plastic pigment latex. (HS3000 NA, from Dow Chemical, Marietta, Ga.), and polyvinyl alcohol (GH17 GOHSNOL, commercially available from Nippon Gohsei, Osaka, Japan) at the dry weight ratio of 90/10. This was then coated and dried at a dry laydown of 27 g/m² on Domtar Quantum® 80 paper using a hopper coater.

### COMPARATIVE EXAMPLE 2

A 25% solids aqueous solution was made containing calcium silicate (HR325 Wollastonite, from R.T. Vanderbilt Company Inc., Norwalk, Conn.), plastic pigment latex (HS3000 NA from Dow Chemical), and polyvinyl alcohol (GH17 GOHSNOL, commercially available from Nippon Gohsei) at the dry weight ratio of 10/80/10. This was then coated and dried at a dry laydown of 27 g/m² on Domtar Quantum® 80 paper using a hopper coater.

### EXAMPLE 3

A 25% solids aqueous solution was made containing calcium silicate (HR325 Wollastonite from R.T. Vanderbilt Company Inc.), plastic pigment latex (HS3000 NA, from Dow Chemical), and polyvinyl alcohol (GH17 GOHSNOL, from Nippon Gohsei) at the dry weight ratio of 25/65/10. This was then coated and dried at a dry laydown of 27 g/m² on Domtar Quantum® 80 paper using a hopper coater.

### EXAMPLE 4

A 25% solids aqueous solution was made containing calcium silicate (HR325 Wollastonite from R.T. Vanderbilt Company Inc.), plastic pigment latex (HS3000 NA, from Dow Chemical), and polyvinyl alcohol (GH17 GOHSNOL, from Nippon Gohsei) at the dry weight ratio of 50/40/10. This was then coated and dried at a dry laydown of 27 g/m² on Domtar Quantum® 80 paper using a hopper coater.

### EXAMPLE 5

A 25% solids aqueous solution was made containing calcium silicate (HR325 Wollastonite from R.T. Vanderbilt Company Inc.), plastic pigment latex (HS3000 NA, from Dow Chemical), and polyvinyl alcohol (GH17 GOHSNOL from Nippon Gohsei) at the dry weight ratio of 75/15/10. This was then coated and dried at a dry laydown of 27 g/m² on Domtar Quantum® 80 paper using a hopper coater.

### EXAMPLE 6

A 25% solids aqueous solution was made containing calcium silicate (HR325 Wollastonite from R.T. Vanderbilt Company Inc.), and polyvinyl alcohol (GH17 GOHSNOL, from Nippon Gohsei) at the dry weight ratio of 90/10. This was then coated and dried at a dry laydown of 27 g/m² on Domtar Quantum® 80 paper using a hopper coater.

### EXAMPLE 7

A 25% solids aqueous solution was made containing calcium silicate (HR325 Wollastonite from R.T. Vanderbilt Company Inc.), Catapal® 200 (boehmite aluminosilicate, AlOOH, from Sasol), and polyvinyl alcohol (GH17 GOHSNOL, from Nippon Gohsei) at the dry weight ratio of 45/45/10. This was then coated and dried at a dry laydown of 27 g/m² on Domtar Quantum® 80 paper using a hopper coater. The coating method can be any coating method known to one skilled in the art of coating.

### EXAMPLE 8

A 25% solids aqueous solution was made containing calcium silicate (HR325 Wollastonite from R.T. Vanderbilt Company Inc.), ALZO NOBEL IJ 200 (SiO₂ from Alzo Nobel, Sayreville, N.J.), and polyvinyl alcohol (GH17 GOHSNOL from Nippon Gohsei) at the dry weight ratio of 45/45/10. This was then coated and dried at a dry laydown of 27 g/m² on Domtar Quantum® 80 paper using a hopper coater.

### EXAMPLE 9

A 25% solids aqueous solution was made containing calcium silicate (HR325 Wollastonite from R.T. Vanderbilt Company Inc.), Albagloss (CaCO₃ from Specialty Minerals, Inc., Bethlehem, Pa.), and polyvinyl alcohol (GH 17 GOHSNOL from Nippon Gohsei) at the dry weight ratio of 45/45/10. This was then coated and dried at a dry laydown of 27 g/m² on Domtar Quantum® 80 paper using a hopper coater.

### EXAMPLES 10 THROUGH 18

A polymeric bead comprised of EmE, where Em is ethyl methacrylate and E is methacrylic acid, at the ratio of Em to E of 95 to 5 and an oxazoline functional copolymer (WS500 from Esprix Technologies) were combined so that the gram/equivalent E functionality was equal to the gram/equivalent oxazoline functionality, to make a 18% aqueous solution. This was then coated over Example 1 through 9 at a dry laydown of 8.6 g/m² and dried.

### EXAMPLES 19 THROUGH 27

A 10% solids aqueous solution of a fumed alumina (Al₂O₃ commercially available as Degussa® VP5111 From Degussa, Germany) was coated at 2.2 g/m² over examples 1 through 9 and dried.

Printing

Each example was then printed with a Canon i550® inkjet printer with Eastman Kodak® pigment inks, with a test target comprised of 1 cm² color patches, a set of each of the primary and secondary colors. Each patch was printed at 100% density.

Fusing and Testing

The printed elements were allowed to dry for 1 hour and then Examples 10 through 18 were fused in a heated nip at 150° C. and 4.2 kg/cm² against a sol-gel-coated polyimide belt at 76 cm/min. Examples 1 through 9 and 19 through 27 were not fused. Each example was then wrapped around a 1-inch diameter tube in both the inward (toward the image side) and outward (away from the image side). Each area was then observed under a 10× magnification to look for any cracks. A scale of 1 to 4 was used to rate each example where:
1=no cracks
2=very slight cracks, not visible to naked eye
3=slight cracks, visible to naked eye
4=heavy cracking

Levels 1 and 2 is considered a passing score, while levels 3 and 4 are failures. The results are shown in Table 1 below.

TABLE 1

| EXAMPLE | BEND INWARD | BEND OUTWARD |
|---|---|---|
| Comparison 1 | 4 | 4 |
| Comparison 2 | 3 | 4 |
| 3 | 2 | 2 |
| 4 | 1 | 1 |
| 5 | 1 | 1 |
| 6 | 1 | 1 |
| 7 | 1 | 1 |
| 8 | 1 | 1 |
| 9 | 1 | 1 |
| Comparison 10 | 4 | 4 |
| Comparison 11 | 3 | 4 |
| 12 | 2 | 2 |
| 13 | 1 | 1 |
| 14 | 1 | 1 |
| 15 | 1 | 1 |
| 16 | 1 | 1 |
| 17 | 1 | 1 |
| 18 | 1 | 1 |
| Comparison 19 | 4 | 4 |
| Comparison 20 | 3 | 4 |
| 21 | 2 | 2 |
| 22 | 1 | 1 |
| 23 | 1 | 1 |
| 24 | 1 | 1 |
| 25 | 1 | 1 |
| 26 | 1 | 1 |
| 27 | 1 | 1 |

The above results show that the elements of the invention had much less cracking than the control elements.

The invention has been described with reference to a preferred embodiment; However, it will be appreciated that variations and modifications can be effected by a person of ordinary skill in the art without departing from the scope of the invention.

1. An inkjet recording element comprising a support having thereon a porous layer, 20 to 70 μm thick, comprising between 75% and 95% by weight of particles in polymeric binder which particles form pores by the spacing between the particles, wherein at least 25 weight percent of the total particles in the porous layer is calcium metasilicate particles in the form of needles having a length of from 1 μm to 30 μm and an aspect ratio of 8:1 to 20:1, wherein the polymeric binder is present in an amount between 5 and 25 weight percent based on the total weight of the layer.

2. The recording element of claim 1 further comprising organic and/or inorganic particles.

3. (canceled)

4. The recording element of claim 2 wherein the weight ratio of the calcium metasilicate to the organic and/or inorganic particles is 30:70 to 70:30.

5. The recording element of claim 1 wherein median particle size of the calcium metasilicate particles is less than 10 μm.

6. The recording element of claim 1 wherein the polymeric binder comprises gelatin, polyurethane, vinyl acetate-ethylene copolymer, ethylene-vinyl chloride copolymer, vinyl acetate-vinyl chloride-ethylene terpolymer, acrylic polymer, polyvinyl alcohol, or a combination thereof.

7. The recording element of claim 21 wherein the recording element farther comprises alumina particles or silica particles wherein the weight ratio of the calcium metasilicate to the alumina or silica particles is 30:70 to 70:30.

8. The recording element of claim 1 wherein the recording element further comprises polymer beads.

9. (canceled)

10. An inkjet recording element comprising a support having thereon a calcium-metasilicate-containing porous layer, 20 to 70 μm thick, comprising between 75% and 95% by weight of particles in a polymeric binder, which particles form pores by the spacing between the particles wherein at least 25 weight percent of the total particles in the porous layer is calcium metasilicate needles having a length of from 10 μm to 50 μm and an aspect ratio of 8:1 to 20:1, wherein the porous layer further comprises organic and/or inorganic particles in the polymeric binder the ratio of the calcium metasilicate needles to the organic or inorganic particles being from 70:30 to 30:70, and wherein the amount of polymer binder is between 5 and 25 percent by weight of the layer.

11. The recording element of claim 10 wherein the calcium-metasilicate-containing layer is an uppermost ink-receiving layer.

12. The recording element of claim 10 wherein the calcium-metasilicate-containing layer is between a support and a porous ink-receiving layer.

13. The recording element of claim 12 consisting essentially of the porous ink-receiving layer and the calcium-metasilicate-containing layer over the support.

14. The recording element of claim 12 wherein the porous ink-receiving layer has interconnecting voids and comprises particles dispersed in a polymeric binder.

15. The recording element of claim 14 wherein the particles are inorganic.

16. The recording element of claim 15 wherein the inorganic particles comprise silica, alumina, zirconia, titania, calcium carbonate, or barium sulfate.

17. The recording element of claim 14 wherein the particles are organic.

18. The recording element of claim 14 wherein the particles have a particle size of from about 5 nm to about 15 μm.

19. The recording element of claim 14 wherein the polymeric binder comprises a hydrophilic binder.

20. The recording element of claim 19 wherein the hydrophilic binder comprises poly(vinyl alcohol), poly(vinyl acetate), poly(vinyl pyrrolidone), gelatin, poly(2-ethyl-2-oxazoline), poly(2-methyl-2-oxazoline), poly(acrylamide), chitosan, poly(ethylene oxide), methyl cellulose, ethyl cellulose, hydroxyethyl cellulose, or hydroxypropyl cellulose.

21. The recording element of claim 14 wherein the polymeric binder comprises a hydrophobic binder.

22. The recording element of claim 21 wherein the hydrophobic binder comprises poly(styrene-co-butadiene), a polyurethane latex, a polyester latex, poly(n-butyl acrylate), poly(n-butyl methacrylate), poly(2-ethylhexyl acrylate), a copolymer of n-butylacrylate and ethylacrylate, or a copolymer of vinylacetate and n-butylacrylate.

23. The recording element of claim 14 wherein the volume ratio of the particles to the polymeric binder is from about 1:1 to about 15:1.

24. The recording element of claim 10 wherein the calcium-metasilicate-containing layer further comprises a mordant.

25. The recording element of claim 10 wherein the support comprises paper or resin-coated paper.

26. The recording element of claim 10 wherein the calcium-metasilicate-containing layer is a base layer under a fusible topcoat comprising fusible organic particles.

27. The recording element of claim 26 wherein the fusible topcoat is a pigment-trapping layer or an ink-transporting layer.

28. The recording element of claim 27 wherein the fusible topcoat is an ink-transporting layer and the recording element further comprises a dye-trapping layer between the ink-transporting layer and the calcium-metasilicate-containing base layer.

29. An inkjet printing process, comprising the steps of:
A) providing an inkjet printer that is responsive to digital data signals;
B) loading the printer with an inkjet recording element as described in claim 1;
C) loading the printer with an inkjet ink composition; and
D) printing on the inkjet recording element using the inkjet ink composition in response to the digital data signals.

30. The process of claim 29 wherein, after printing at least the top layer of the inkjet recording element is fused to form a continuous, non-light scattering layer containing the printed image.
